(19) United States
(12) Patent Application Publication
(10) Pub. No.: US 2008/0218920 A1
(43) Pub. Date: Sep. 11, 2008

(54) METHOD AND APARATUS FOR IMPROVED ELECTROSTATIC DISCHARGE PROTECTION

(75) Inventors: Pieter Vanysacker, Pittem (BE); Olivier Marichal, Nieuwerkerken-Aalst (BE); Bart Sorgeloos, Pittem (BE); Benjamin Van Camp, Antwerp (BE); Bart Keppens, Gistel (BE); Johan Van der Borght, Meldert (BE)

Correspondence Address: PATENT DOCKET ADMINISTRATOR;LOWENSTEIN SANDLER P.C., 65 LIVINGSTON AVENUE, ROSELAND, NJ, 07068, US

(73) Assignees: SARNOFF CORPORATION, Princeton, NJ (US); SARNOFF EUROPE BVBA, Gistel (BE)

(21) Appl. No.: 12/043,206

(22) Filed: Mar. 6, 2008

Related U.S. Application Data
(60) Provisional application No. 60/893,670, filed on Mar. 8, 2007.

(51) Int. Cl. H02H 9/04

(52) U.S. Cl. 361/56

(57) ABSTRACT

An apparatus having an inter-domain electrostatic discharge (ESD) protection circuit for protection of an integrated circuit (IC) with multiple power domains. The protection circuit in response to an ESD event provides an ESD protection between different power domains. Specifically, the protection circuit comprises at least one clamp coupled to one power domain, which conducts current during an ESD event to provide extra current in the interface line between the two different power domains. This extra current also in turn increases the voltage over the impedance element on the interface line, thus improving the design margins for the ESD protection and providing a better ESD protection capability for IC products.

### CROSS REFERENCES

This patent application claims the benefit of U.S. Provisional Application Ser. No. 60/893,670 filed Mar. 8, 2007, the contents of which are incorporated by reference herein.

### FIELD OF THE INVENTION

The present invention generally relates to circuits that provide electrostatic discharge protection, and more particularly to method and apparatus for providing ESD protection of interfaces between different power domains.

### BACKGROUND OF THE INVENTION

It is known in the art to protect the IO cells when protecting an IC with multiple power domains against ESD stress. However, the voltage difference between different power domains during the stress can be so severe that protection of the interfaces between the different domains inside the core circuitry is also needed. This is especially the case for Charge Device Model (CDM) stress. One way to protect the interface between the different power domains is by providing what is known as inter-domain protection.

Referring to FIG. 1, there is show an inter-domain protection circuit for ESD protection 300 in accordance with the prior art. The circuit 100 includes two different voltage domains at nodes 102 and 103 and their corresponding ground voltages at nodes 101 and 116 respectively. The interface circuit between the two voltage domains at 102 includes preferably a PMOS transistor 106 in series with preferably a NMOS transistor 107, specifically connected between the voltage 102 and the ground 116. The interface circuit at node 103 includes at least one of two ESD clamps 104a and 104b in parallel connection with preferably a PMOS transistor 108 and an NMOS transistor 109. Note that the clamps, 104a and 104b and the transistors 108 and 109 are connected between the voltage 103 and ground 101. Also, provided in the circuit 100 is a resistor 105, in the interface line 115 between an input port 114 and the gate of the transistors 106 and 107 (at voltage domain 102), as shown in FIG. 1. The input port 114 is situated between the two ESD clamps 104a and 104b which is the input to the gates of the PMOS 108 and the NMOS 109 transistors at the voltage domain 103. Moreover impedance element 110 is provided in the interface line between the ground voltages 101 and 116. Impedance element 110 is provided in the interface line between the ground voltages 101 and 116. This could be any element from the group of resistor, diode, MOS, SCR, inductor, etc or any series or parallel connection of said elements. In a typical case this is a series connection of a resistor (representing the bus resistance in ground bus 101), a pair of diodes coupled in anti-parallel and another resistor (representing the bus resistance in ground bus 116).

Note that the inter-domain protection, as illustrated in FIG. 1, involves the use of the resistance 105 to limit the ESD current flowing into the interface line and the ESD clamps 104a and 104b at the gates of the input port 114 to locally clamp the voltage so that the gate oxide of the input NMOS 109 or PMOS 108 doesn't break down. Suppose positive ESD stress occurs at node 102 with respect to ground 101 of the other voltage domain 103. While the major part of the ESD current 111a will flow through the power clamp between the voltage node 102 and the ground node 116, and through the ground nodes 116 and 101, a certain amount of current 111b, typically only a few mA, will flow through the transistor 106 into the interface line 115 into the resistor 105 and the ESD clamp 104b at the input. The major current 111a through the power clamp of the voltage domain 102 and the ground busses 101 and 116 creates a voltage drop between the nodes 102 and 101. This voltage drop will be transferred by the interface circuit to the other voltage domain and will occur over the gate oxide of transistor 109 without inter-domain protection and is large enough to destroy the transistor 109. To prevent this, the voltage is clamped by the ESD clamp 104b and a resistance 105 is added. This causes the largest part of this voltage drop to occur over the resistor 105 instead of the input gate oxide of transistor 109. However, the current through this resistance is typically not large enough to absorb enough of the voltage drop and protect the driver from break-down.

Thus, for a given ground bus voltage drop, it is clear that there are at least three important elements which need to be taken into account in the circuit. One is the size of the ESD clamp 104b, the line resistance 105 and the size of the line driver transistor 106. Most important is the line resistance 105, as this will determine the current flowing through it for a given bus voltage. For higher voltage drops (higher ESD), the impedance 105 needs to be increased in order to obtain enough voltage across it for the same line current 111b. However in practical applications, due to design restrictions, it is not always possible to increase the line resistance 105 because this reduces the speed performance of these interface circuits and can increase the power consumption needed to drive this line. Another solution is to increase the size of the driver transistor 106 so that it can source or sink more current into the line. However this is also not desirable because this will also have negative influence on important design specifications such as power consumption. Furthermore, because of the sensitivity of these parameters, the circuit designer typically will not allow the ESD designer to change any of the interface circuits themselves. Even another solution is to increase the size of the ESD clamp. However, firstly, by increasing the size of the ESD will dramatically enlarge the silicon area consumed for this ESD protection, and secondly by increasing the size of the ESD clamp for the same line resistance, driver size and bus voltage drop, the required current will increase. In that case the driver can fail if it can't handle this extra current.

Thus, there is a need in the art to provide an inter-domain protection technique for ESD protection of interfaces between different power domains that overcomes the disadvantages of above discussed prior art.

### SUMMARY OF THE INVENTION

In one embodiment of the present invention, there is provided an electrostatic discharge (ESD) protection circuit for protecting an integrated circuit with multiple power domains. The ESD protection circuit comprises at least a first MOS transistor coupled between a first voltage supply line and a first ground potential; at least a second MOS transistor coupled between a second voltage supply line and one of the first ground potential and a second ground potential. The circuit also comprises at least a first ESD clamp coupled between the first voltage supply line and the first ground potential. The first ESD clamp is placed parallel to the first MOS transistor. The circuit also comprises at least a second ESD clamp coupled between the second voltage supply line and at least one of the first and second ground potentials. The second ESD clamp is placed parallel to the second MOS transistor. The circuit further comprises at least one impedance circuit placed between the first MOS transistor and the second MOS transistor, wherein the first ESD clamp conducts current and provides at least a portion of the current in the impedance circuit in response to an ESD event.

### BRIEF DESCRIPTION OF THE DRAWINGS

The present invention will be more readily understood from the detailed description of exemplary embodiments presented below considered in conjunction with the attached drawings, of which:

FIG. 1 depicts a block diagram of an inter-domain ESD protection circuit in accordance with the prior art of the present invention.

FIG. 2 depicts a block diagram of an improved inter-domain ESD protection circuit in accordance with a first embodiment of the present invention.

FIG. 2A depicts a block diagram of a current flow in FIG. 2.

FIG. 2B depicts a block diagram of a current flow in FIG. 2.

FIG. 2C depicts a block diagram of a current flow in FIG. 2.

FIG. 2D depicts a block diagram of a current flow in FIG. 2.

FIG. 3 depicts a schematic diagram of the improved inter-domain ESD protection circuit of FIG. 2 in accordance with a preferred embodiment of the present invention.

FIG. 3A depicts a schematic diagram of the current flow in FIG. 3.

FIG. 4 depicts a schematic diagram of an improved inter-domain ESD protection circuit of FIG. 2 in accordance with a preferred embodiment of the present invention.

FIG. 4A depicts a schematic diagram of a current flow in FIG. 4.

FIG. 4B depicts a schematic diagram of a current flow of combination of FIG. 3A and FIG. 4A in accordance with one preferred embodiment of the present invention.

FIG. 4C depicts a schematic diagram of a current flow of combination of FIG. 3A and FIG. 4A in accordance with another preferred embodiment of the present invention.

FIG. 5 depicts a schematic diagram of an improved inter-domain ESD protection circuit of FIG. 2 in accordance with a fourth embodiment of the present invention.

FIG. 6 depicts a block diagram of an improved inter-domain ESD protection in accordance with a fifth embodiment of the present invention.

FIG. 6A depicts a block diagram of a current flow in FIG. 6.

FIG. 7 depicts a block diagram of an improved inter-domain ESD protection in accordance with a sixth embodiment of the present invention.

FIG. 7A depicts a block diagram of a current flow in FIG. 7.

FIG. 8 depicts a block diagram of an improved inter-domain ESD protection in accordance with a seventh embodiment of the present invention.

FIG. 8A depicts a schematic diagram of a current flow in FIG. 8.

FIG. 9 depicts a block diagram of an improved inter-domain ESD protection in accordance with an eighth embodiment of the present invention.

FIG. 9A depicts an exemplary schematic diagram of an improved inter-domain ESD protection circuit of FIG. 9 in accordance with a preferred embodiment of the present invention.

FIG. 9B depicts an exemplary schematic diagram of an improved inter-domain ESD protection circuit of FIG. 9 in accordance with a preferred embodiment of the present invention.

FIG. 10 depicts a schematic diagram of the improved inter-domain ESD protection circuit of FIG. 2 in accordance with a preferred embodiment of the present invention.

FIG. 10A depicts a schematic diagram of the current flow in FIG. 10.

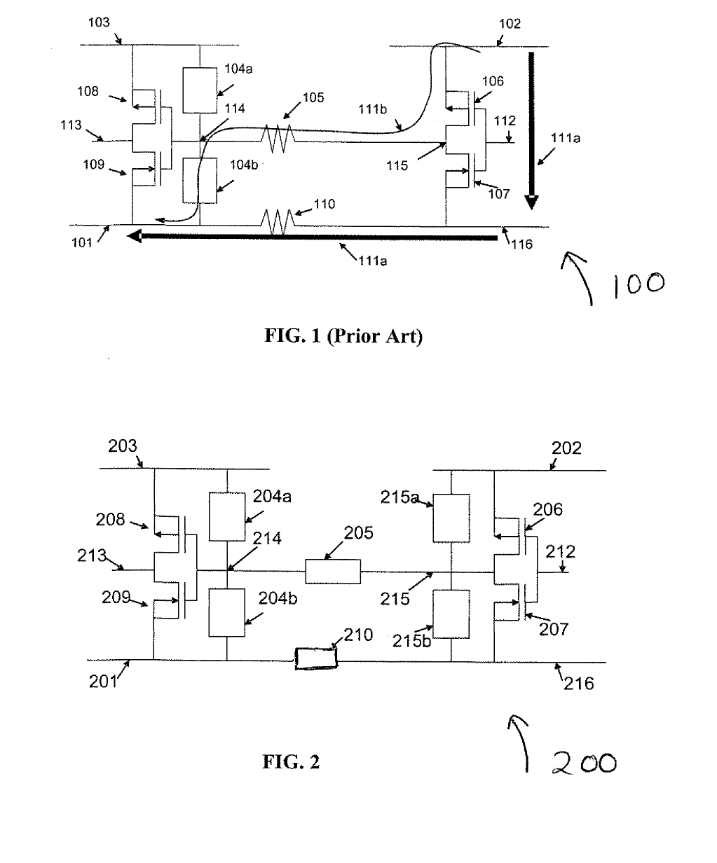

It is to be understood that the attached drawings are for purposes of illustrating the concepts of the invention.

### DETAILED DESCRIPTION OF THE INVENTION

The present invention provides an improvement of the inter-domain protection technique for ESD protection of interfaces between different power domains on an IC. Specifically, the present invention proposes a solution to increase the current through the interface line and thus increase the voltage drop over the line, without changing the line driver itself. It also proposes an approach to increase the impedance of the interface line during ESD and thus increase the voltage drop over it. An increase of voltage over the interface line improves the design margins for the ESD protection strategy, and thus provides a better ESD protection capability for IC products.

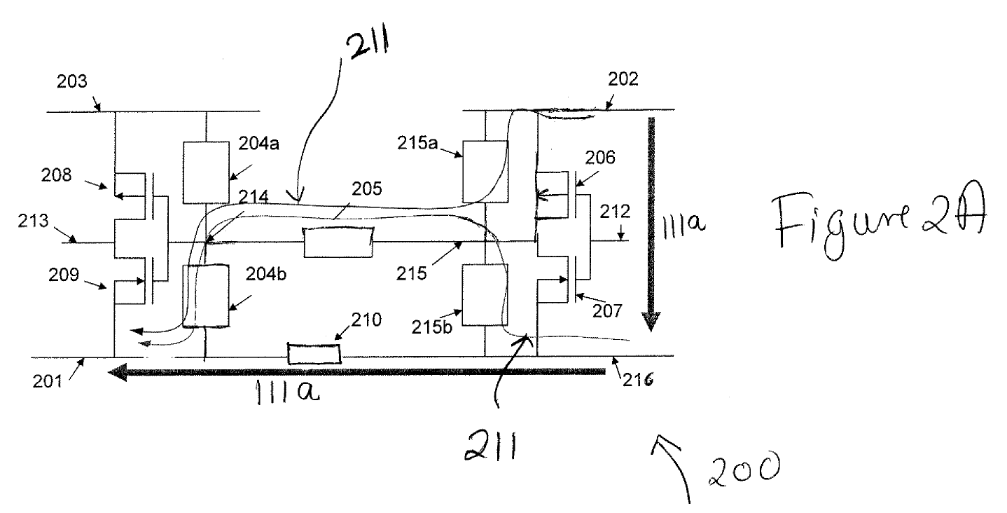

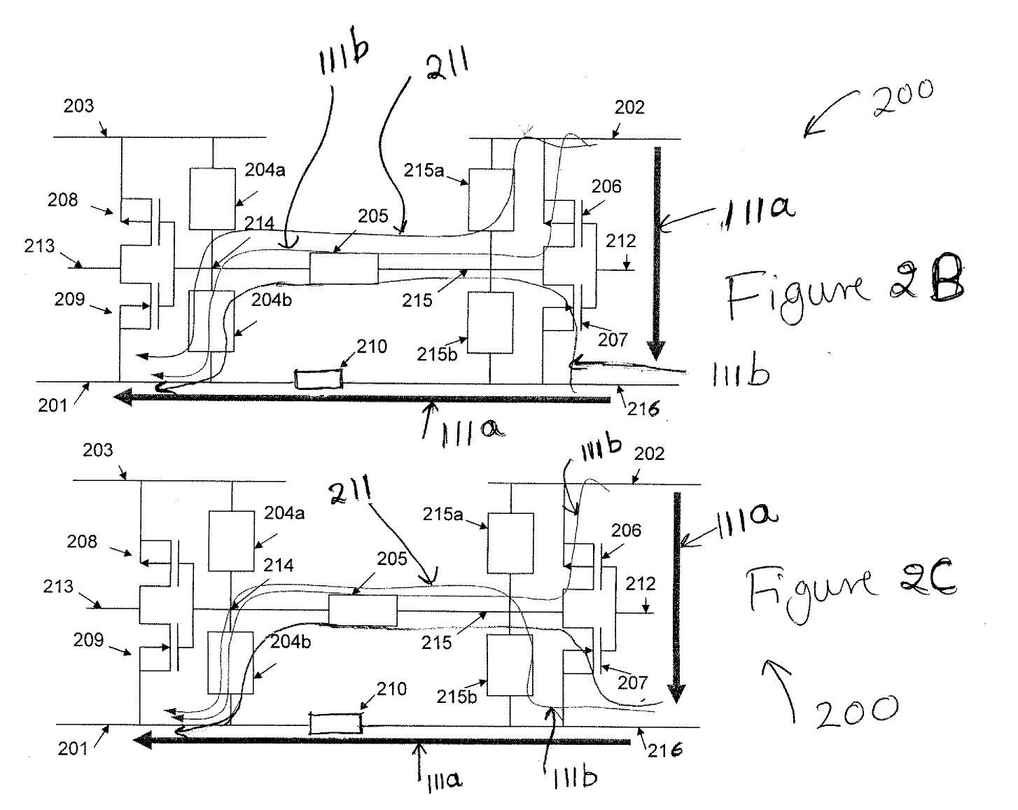

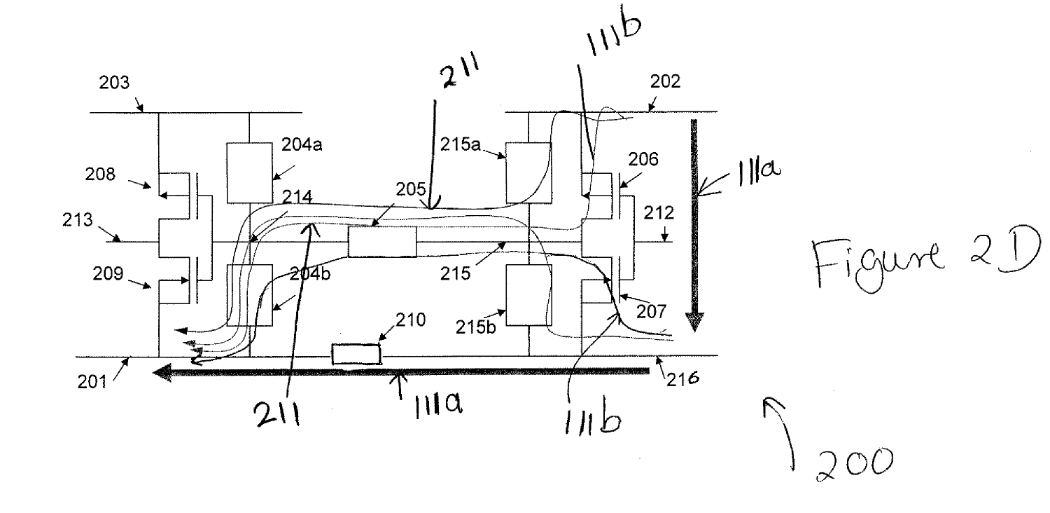

In one embodiment of the present invention, FIG. 2 illustrates a generic implementation of a first embodiment of the improved inter-domain ESD protection circuit 200. The ESD protection circuit 200 includes a few similar elements to the circuit 100, but is not restricted to a resistor 105 and could be any impedance device 205 of the interface line 215, as shown in FIG. 2. Impedance element 210 is provided in the interface line between the ground voltages 201 and 216. This could be any element from the group of resistor, diode, MOS, SCR, inductor, etc or any series or parallel connection of said elements. In a typical case this is a series connection of a resistor (representing the bus resistance in ground bus 201), a pair of diodes coupled in anti-parallel and another resistor (representing the bus resistance in ground bus 216). Additionally, the circuit 200 also includes two ESD clamp devices 215a and 215b, which is added to conduct secondary current (element 211 in FIGS. 2A, 2B, 2C and 2D) during an ESD event and thus sink more current through the impedance element 205 of the interface line 215. Thus, by sinking more current into the line impedance 205, the value of the impedance 205 can be controlled at a lower value, preferably a few hundred ohms or less depending on the amount of current for the same voltage drop or the voltage drop over the impedance device 205 can be increased. This voltage drop over the impedance 205 in turn then lowers or limits the voltage drop over the gate of the transistor 209 and the driver, thus preventing the break-down of the gate oxide of transistor 209 or the driver. Therefore, this implementation allows for better inter-domain protection with lower line resistance at the impedance 205 and unchanged line driver transistors 206 and 207, which can be a significant advantage in some high speed applications between the two different voltage domains. Note that even though two clamp devices 215a and 215b are shown in FIG. 2, the circuit 200 may preferably include only one clamp device to conduct current during an ESD event. For example, in the case where ESD current flows from supply line 202 to ground line 201, only one clamp device 215a might be sufficient in the circuit 200 to provide the secondary current in the interface line 215. In another example, in the case where ESD current flows from ground line 216 to supply line 203 or to ground line 201, only one clamp device 215b might be sufficient in the circuit 200 to provide the secondary current in the interface line 215. Another example is where the ESD current is flowing from the supply line 203 to the ground 216. In this case the secondary current will flow through the ESD clamp 204a, the impedance element 205 and the ESD clamp 215b.

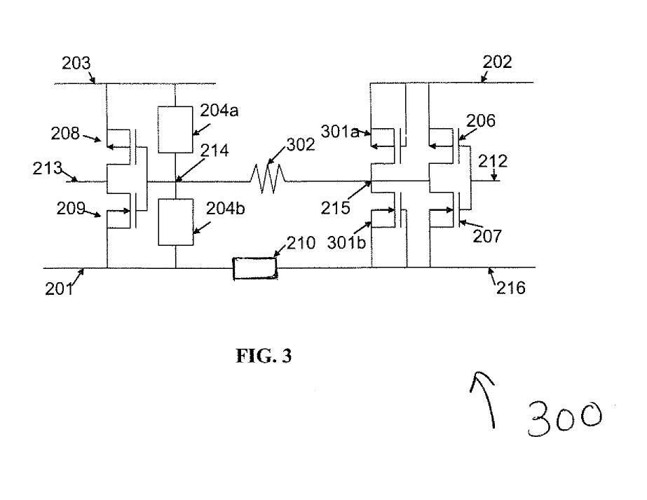

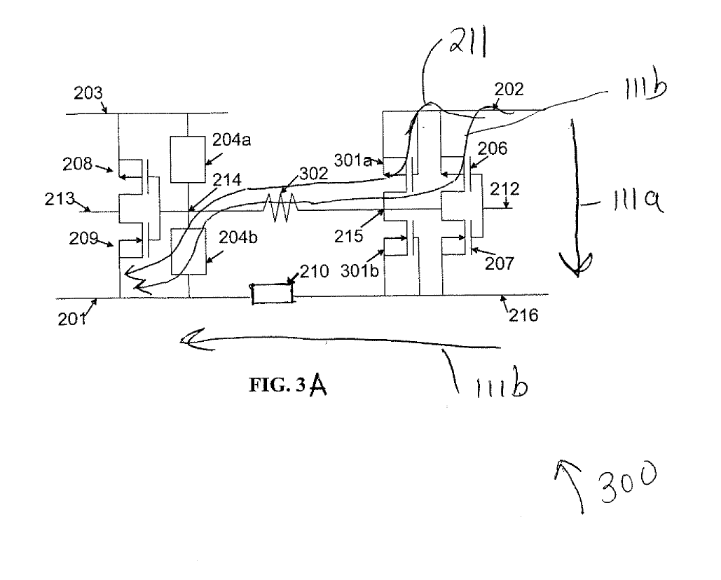

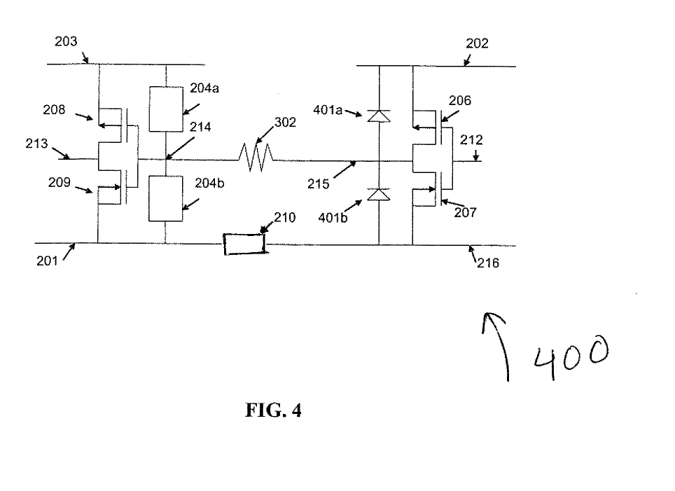

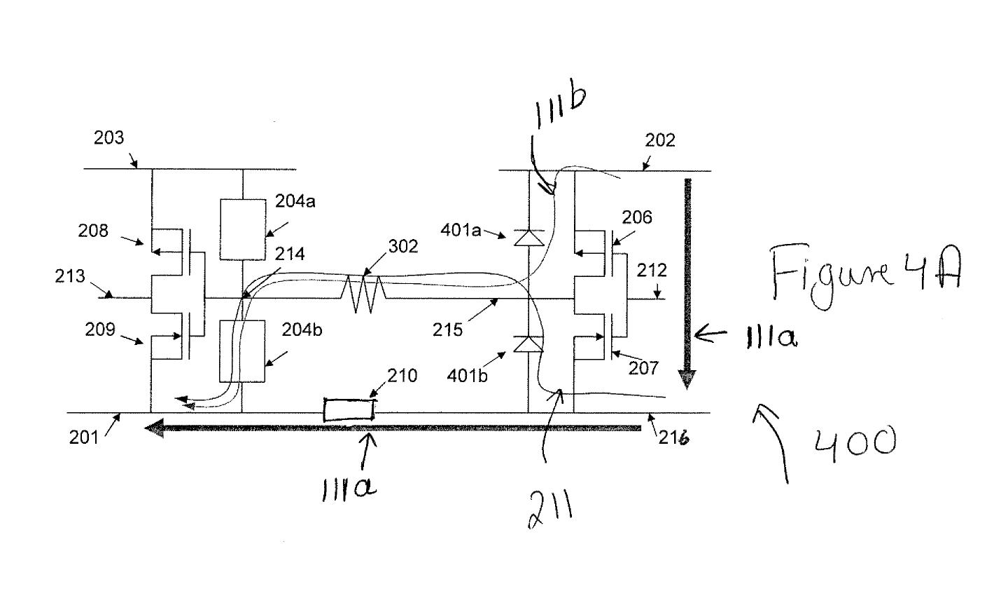

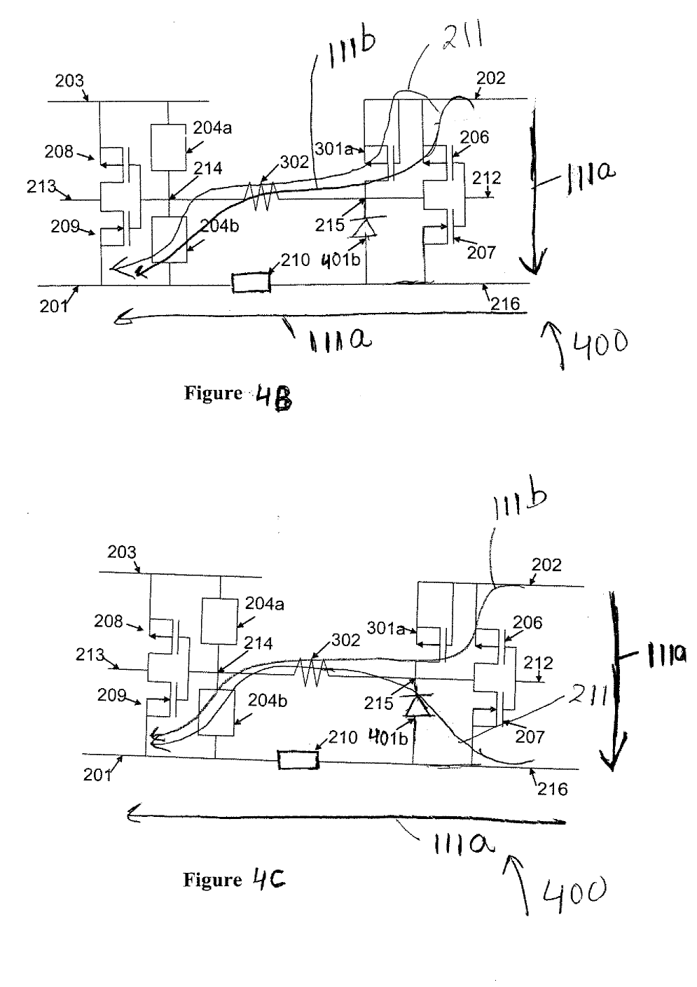

Note that the clamp devices 215a and 215b will need to conduct a small or large part of the current 211 through the line 215, depending on how much current the interface circuits themselves can sink into the interface line during the ESD event. FIG. 2A shows the clamp devices 215a and 215b conducting all of the secondary current 211 through the line 215. Even though not shown, the driver transistors 206 and 207 can be conducting some part of the current, however, in typical cases it is negligible to the protection devices. When only a part of the secondary current 211 is conducted by clamp devices, the output driver transistors 206 and 207 will conduct the remaining part of the current 111b as shown in FIGS. 2B, 2C and 2D. FIG. 2B illustrates a case scenario where only clamp device 215a conducts the additional current 211, which will be described in greater detail with embodiment of FIGS. 3 and 3A below. FIG. 2C illustrates a case scenario where only clamp device 215b conducts the additional current 211, which will be described in greater detail with embodiment of FIGS. 4 and 4A below. FIG. 2D illustrates a case scenario where both clamp devices 215a and 215b conduct the additional current 211, which is described in greater detail with embodiment of FIG. 4B and FIG. 4C below.

Further, note that the ESD clamp devices 215a and 215b and the active line impedance 205 can preferably be any device such as a coil, a diode, MOS, SCR, etc. In case of an active device such as a MOS or SCR, it is possible to add some trigger circuitry as well. Note that the present invention is also applicable to other interface configurations besides the standard CMOS inverter as illustrated in FIG. 2. Some examples of other interface configurations are cascaded NMOS/PMOS configuration, open drain MOS circuitry

Referring to FIGS. 3 and 3A, there is shown a preferred embodiment of the inter-domain ESD circuit 300 of the present invention. The circuit 300 preferably provides a line resistor 302 to function as the impedance element 105 and GGNMOS transistors 301a and 301b to function as the ESD clamps 215a and 215h of the circuit 200. This could be necessary when no changes can be made to the driver transistors 206 and 207 because of design restrictions. In this case the gate of transistor 301b is connected to the ground terminal 216 and the gate of transistor 301a is connected to the voltage line 202. This causes both of the transistors, 301a and 301b to be in the off state. Additionally, these gates can be connected to a circuit to control the state of transistors 301a and 301b during normal operation and ESD operation. Consider, for example, the case where ESD current 111a flows from voltage line 202 to ground line 201 through element 210. A voltage will be built up over the gate oxide of transistor 209 causing it to break down. To prevent this, the voltage is clamped by an ESD clamp 204b to a safe value. As soon as this happens, the clamp 204b starts to conduct current 111b. This current 111b must be delivered from the line which draws it from the PMOS transistor of the driver 206 as shown in FIG. 3. Because this transistor 206 is usually very small, the current it can source will be limited. Therefore, an additional transistor 301a is added to be connected in parallel to the PMOS driver 206 to conduct additional current 211 during ESD. So, as soon as the voltage over the transistor 301a becomes higher than its trigger voltage, the transistor 301a will start to conduct current 211 in parallel with 206. This provides extra current 211 in the interface line 215 which will in turn increases the voltage over the line resistance 302. This current flow is illustrated in FIG. 3A. Note that by increasing the voltage over the resistance line, the design margins for the ESD protection become larger, such as the line resistance 302, can then be decreased or the maximum allowed ground bus impedance level (element 210) can be increased. If for example, the ESD stress is at line 216, then the transistor 301b will be turned on by the excessive voltage and will start to conduct the secondary current 211 to sink this current in the line impedance 205 in the interface line 215.

Referring to FIGS. 4 and 4A, there is shown another preferred embodiment of the rubber banding ESD circuit 400 of the present invention. The circuit 400 preferably provides a line resistor 402 to function as the impedance element 105 and diodes 401a and 401b to function as the ESD clamps 215a and 215b of the circuit 200. As discussed above, in the prior art, during ESD stress from supply line 202 to ground line 201, the current 111a will flow through the power clamp between voltage line 202 and the ground bus 216, through the ground busses 216 and 201 and the impedance element 210. This will create a large voltage drop between the voltage nodes 201 and 202. As a result, the voltage over the gate oxide of transistor 209 will build up to a dangerous value causing it to break down. To prevent this, the voltage is clamped by ESD clamp 204b to a safe value. As soon as this happens, the clamp 204b starts to conduct current 111b. This current is delivered from the interface line 215 which draws from transistor 206, as illustrated in FIG. 4A. Because of this current flowing through the transistor 206, it is easily possible that the voltage over transistor 206 becomes higher than the voltage between voltage line 202 and the input port 216. As soon as this happens, diode 401b will become forward biased and will conduct current 211, which increases the current through the interface line 215, while relieving transistor 206 from further stress, as illustrated in FIG. 4A. Therefore this implementation is able to source more current into the interface line without altering transistor 206. Moreover, the diode 401b additionally functions to boosts the current flowing through the resistor 302 which again allows further reducing the value of the resistor 302.

Although not shown, a similar situation may occur when ESD stress occurs at voltage node 216 with respect to node 203. In this case, most of the current will flow through the ground bus 201 and impedance element 210 to the ground bus 216, and through the power clamp between voltage line 203 and the ground bus 201. In this case, a large voltage drop will exist at the gate oxide of transistor 208 and ESD clamp 204a will clamp this voltage to a safe value. When this happens, current will flow through from the port 216 to the interface line 215 which is sourced by the parasitic diode in the transistor 207. Because this diode is usually very weak, the diode 401b will conduct most of the current and therefore increases the voltage drop over the line resistance 402. This further creates more margins for the operation of the ESD protection.

In another preferred embodiment of the present invention, the transistor 301a may function as ESD clamp 215a, and diode 401b may function as ESD clamp 215b as shown in FIG. 4B & FIG. 4C respectively. As discussed with reference to FIG. 3A above, similarly, in FIG. 4B, during LSD event, the transistor 301a will start to conduct the current 211 in parallel with 206. This provides extra current 211 in the interface line 215 which will in turn increases the voltage over the line resistance 302. Also, as discussed with reference to FIG. 4A above, similarly in FIG. 4C, during ESD event, diode 401b will become forward biased and will also conduct extra current 211, which increases the current through the interface line 215, while relieving transistor 206 from further stress.

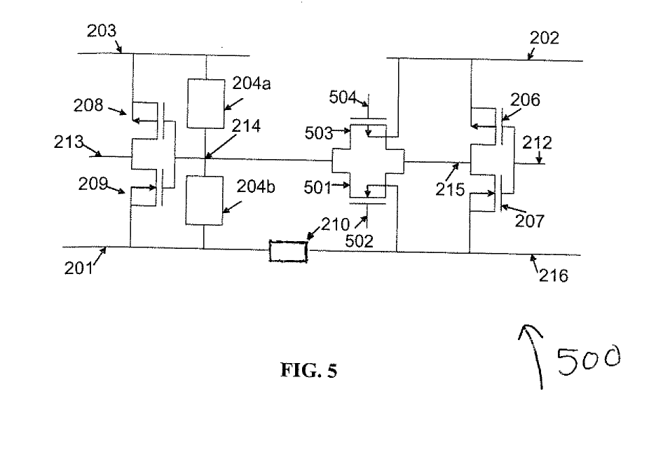

Referring to FIG. 5, there is shown another embodiment of the improved inter-domain ESD protection circuit 500 of the present invention. In the circuit 500, the active impedance element 105 of FIG. 2 is realized by using a pass gate, consisting of transistors 501 and transistor 503. So, instead of using a fixed value resistance for the impedance element 105, the value of the resistance for element 105 consisting of transistors 501 and 503 is determined by whether it is under normal operation or under ESD. The value is determined by the gate voltage. The purpose is to have a high impedance path in the interface line 215 during ESD. During normal operation however, the line resistance 105 should be as low as possible. As illustrated in FIG. 5, the bulk of the transistor 501 is connected to ground line 216 and the bulk of transistor 503 is connected to supply line 202. The gate of transistor 501 is driven with a control signal 502 and the gate of the transistor 503 is driven with a control signal 504. Note, the control signals 502 and 504 are opposite to each other. During normal operation of the IC signal 502 is logic high, and signal 504 is logic low. Under this condition both transistors 501 and 503 are turned on and the pass gate will have low impedance. In this case the secondary current 211 (not shown) can flow freely from drain to source through the transistors 501 and 503 of the pass-gate. However, during ESD, high impedance is desired. So, in this case control 502 should be logic low and control signal 504 is logic high and thus, both transistors 501 and 503 are then turned off. In this case the ESD secondary current 211 (not shown) trying to flow from drain to source through these transistors 501 and 503 of the pass-gate see a high impedance.

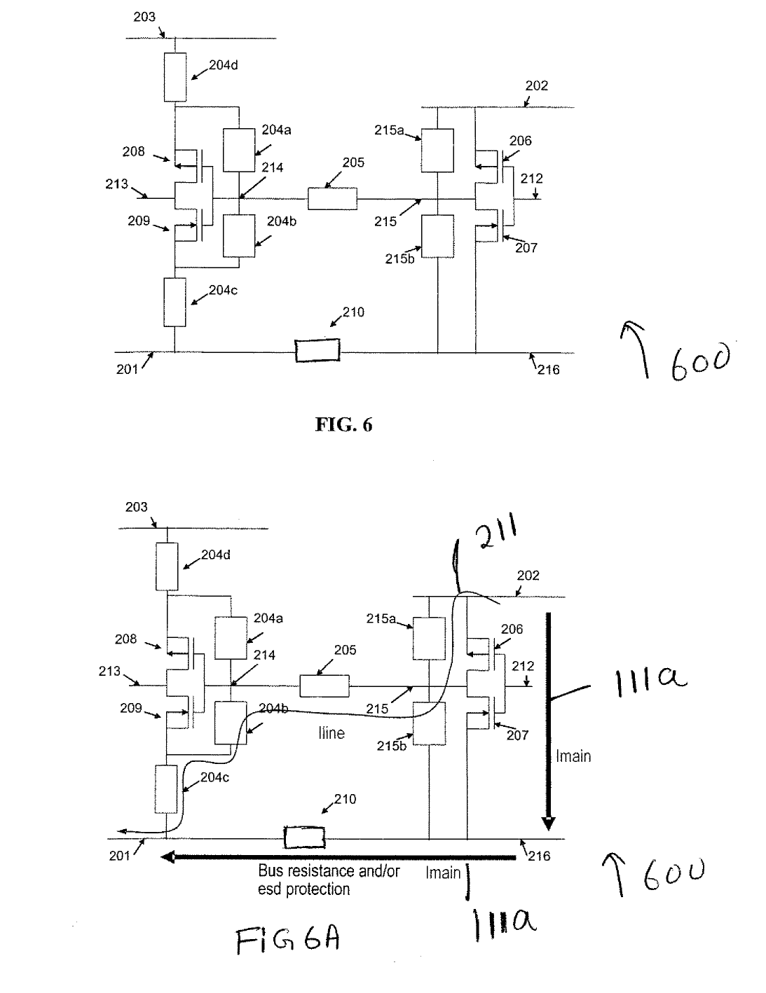

Referring to FIGS. 6 and 6A, there is shown another embodiment of the improved inter-domain ESD protection circuit 600 of the present invention. In the circuit 600, besides the ESD clamps 204a and 204b provided in FIG. 2, additional ESD clamps 204c and 204d are added as shown. ESD clamp 204c is added between the source of the transistor 209 and ground 201 and is also connected in series to the ESD clamp 204b. ESD clamp 204d is added between the source of the transistor 208 and voltage node 203 and is also connected in series to the ESD clamp 204a. So, consider a case where ESD current flows from supply line 202 to ground 201. In this embodiment, in order to limit the voltage build up at the gate of the transistor 209, ESD clamp 204c is added, which itself has some resistance, thus dividing the voltage between the impedance element 205 and ESD clamp 204c. So, in this implementation, the voltage built up is not only over the element 205 but also over the element 204c as shown in FIG. 6A. One of the advantages is that if you need a high resistance, for example, 1 Kohm, it can be divided between the elements 205 and 204c. So, during ESD, in order to prevent the voltage built up, not only does the ESD clamp 204b conducts current 211, but the ESD clamp 204c also begins to conduct current 211 as shown in FIG. 6A. It is noted that in many cases, simply by placing the ESD clamp 204c at the source of the transistor 209, the impedance element 205 is not required, if the impedance of this clamp 204c at the source of the transistor 209 is high enough.

Note that similar application as discussed above, applies when there is ESD stress between the supply line 202 and supply line 203. In this case, during ESD event, the current will then flow from supply line 202 to 215a, then through the impedance element 205 to the ESD clamp 204a and then to ESD clamp 204d. In this case scenario, the voltage build up will be divided between the impedance element 205 and the ESD clamp 204d. Furthermore, even though, not shown, in another embodiment, in many cases (where the high resistance is not required), elements 205, 215a and 215b can be eliminated from the circuit 600.

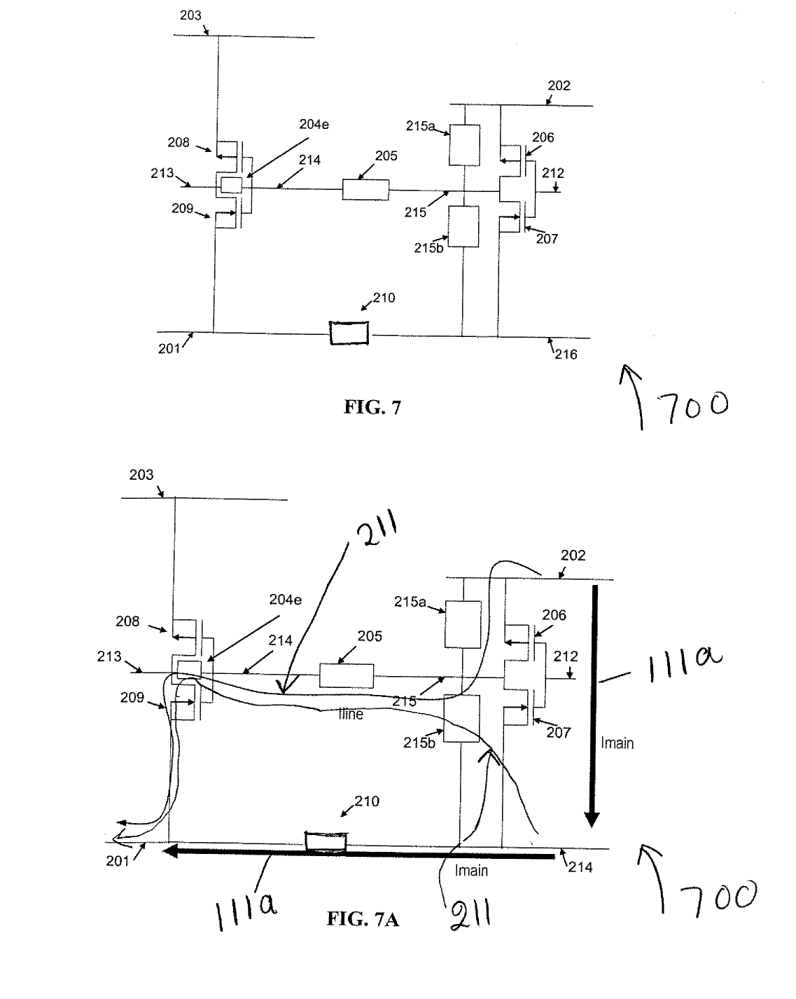

Referring to FIGS. 7 and 7A, there is shown another embodiment of the improved inter-domain ESD protection circuit 700 of the present invention. In the circuit 700, the ESD clamps 204a and 204b of FIG. 2 are eliminated and instead a single ESD clamp 204e is added between the input port 216 and the input terminal 213. One of the advantages of eliminating clamps 204a and 204b and placing only one ESD clamp 204e between the transistors 208 and 209 is to reduce the area and further reduce the capacitance at the interface line 214. The resistance value of the impedance element 205 is limited for the speed of the transistor. So, in high speed transmissions, impedance element 205 is no longer combined with the enlarged capacitance from the gate oxide and the ESD clamp 204a and 204b. If this capacitance value is multiplied by the resistance of the channel, this gives the intrinsic time constant of the interface stage. The intrinsic time constant places a limit on the speed the transmitter can operate at because higher frequency signals will then be filtered out.

Referring to FIG. 7A, there is illustrated the current flow of the circuit 700 during an ESD event. During normal operation, the ESD clamp 204e will be off, so this limits the current flowing from the input port 214 to the terminal 213 continuing into the transistor 209 and finally to ground 201. And during ESD stress, the voltage at node 202 will be transferred to the input port 214. The voltage at this node will increase until the trigger voltage of clamp 204e is reached. Then an additional current 111b is allowed to flow from the supply line 202 through the transistor 206 and clamp 215a into the line impedance. The current is then flowing to the terminal 213 through a single clamp, 204e. After this, the current can flow through the input transistor 209 from drain to source and to the ground 201. Furthermore, even though, not shown, in another embodiment, in many cases where the added current sinking capability is not required, elements 215a and 215b can be eliminated from the circuit 700.

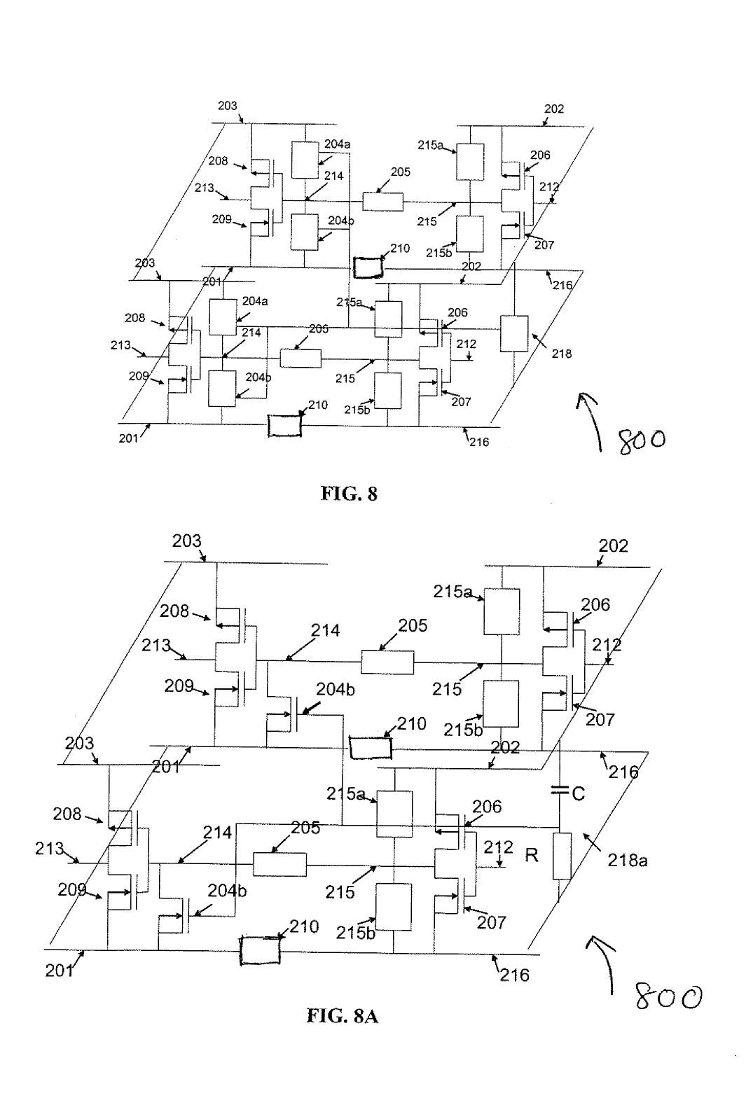

Often there will be multiple inter-domain interfaces. One of the examples of such connections is illustrated in FIG. 8. Note that in exemplary FIG. 8, a multiple inter domain connection 800 is shown which consists of at least two interface protection circuits 200. Note that the multiple inter domain connections are not limited to FIG. 8, one skilled in the art would appreciate that other multiple inter domain connections can be made as well. Because there are now multiple ESD clamps 204a and 204b and multiple impedance elements 205 is needed, an ESD detector 218 is preferably placed and shared over the different clamps as illustrated in FIG. 8. Note that by connecting the ESD detector 218 to the ESD clamps 204a and 204b, as shown in FIG. 8, will help trigger the clamps 204a and 204b much faster. Also, since this ESD detector 218 is normally too large for only one connection, it may preferably be shared over the different multiple connections, thus, reducing the total surface area of the inter-domain protection. So, in this manner, only one trigger circuit, i.e. ESD detector 218 is used for the entire multiple inter-domain interface.

Further note in FIG. 8, that the connection between the two circuits 200 is preferably connected to the gate of the local clamps (NMOS) 204b placed at the inputs. Again, note that the connection between the two protection circuits 200 is not limited to the local clamps 204b and one skilled in the art would appreciate that other connections can also be made between the two circuits. Although, not shown, in one preferred embodiment, the ESD detector 216 can also preferably be connected to clamps 215a and 215b. Alternatively, elements 215a and 215b can be also eliminated from the connection circuit 800.

In a preferred embodiment of the present invention the ESD detector circuit 218, is a RC transient detector 215a comprising of a resistor and a capacitor as shown in FIG. 8A. Again, note that the ESD detector 218 is not limited to RC transient detector 218a. One skilled in the art would appreciate that other ESD detectors, such as RC transient detector combined with feedback techniques or inverter stages, or even over-voltage/over-current sensing devices can be used as trigger elements and shared among multiple inter-domains.

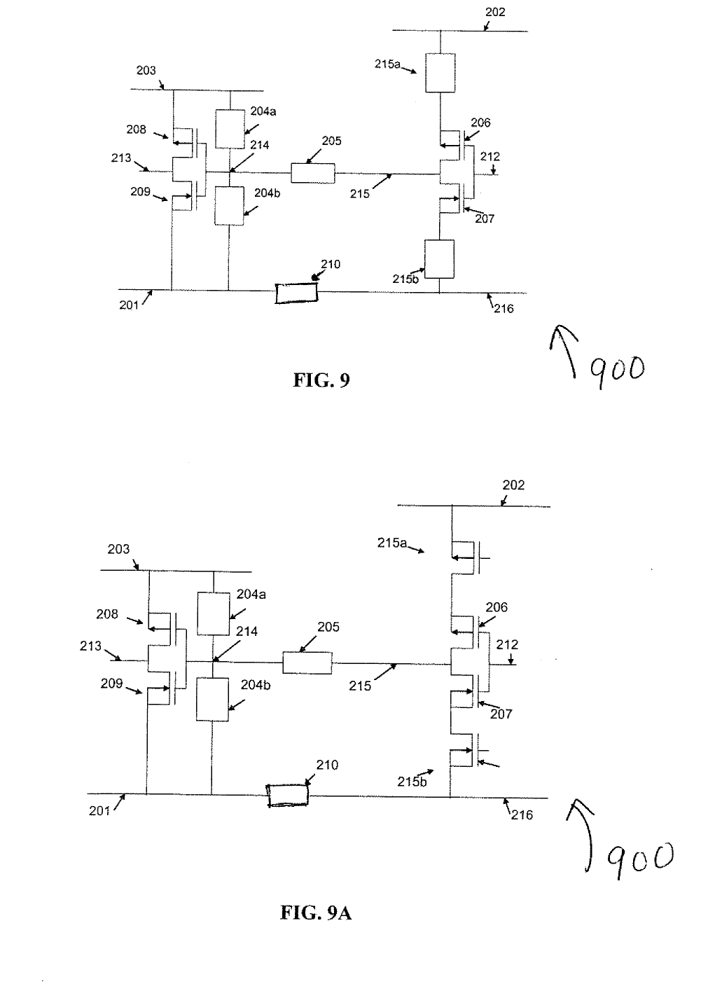

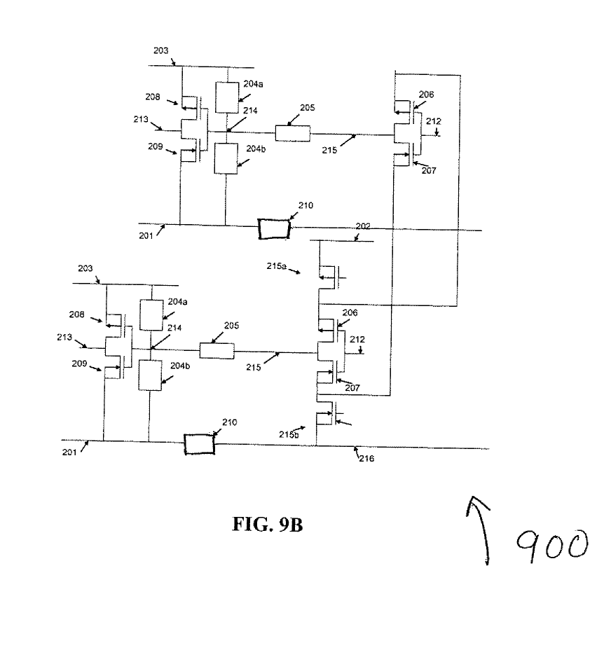

Referring to FIG. 9, there is shown an alternate embodiment of the improved inter-domain ESD protection circuit 900 of the present invention. Note that instead of placing the ESD clamp 215a in parallel with the driver 206 between the power supply and circuit node 215 as shown in FIG. 2, the ESD clamp 215a in FIG. 9 is instead placed in series with the output driver, thus between the power line 202 and the source of the transistor 206. Similarly, instead of placing the ESD clamp 215b in parallel with driver 207, between the ground node 216 and the circuit node 215 as shown in FIG. 2, the ESD clamp 215b in FIG. 9 is instead placed in series with the output driver between the ground 216 and the source of the transistor 207. Note that this series connection of the ESD clamps with the interface drive circuits, reduces the voltage drop that the line impedance 205 needs to absorb, by placing some of the total ESD voltage between 202 and 201 (for stress between those two nodes) across the series element.

In a preferred embodiment of the present invention, the ESD clamps 215a and 215b are NMOS and a PMOS respectively, as shown in FIG. 9A. So a cascaded driver is formed. So, for example during ESD stress at node 202, the voltage built up between the node 202 and interface line 215 is equal to the voltage across ESD clamp 215a and the PMOS 206 i.e. two times that of single PMOS 206. Because this extra voltage drop is now no longer required to be absorbed by the line impedance 205, the value of the resistance of the impedance element 205 can be decreased.

In another embodiment of the present invention, the cascaded driver 215a and 215b of FIG. 9A can preferably be also applied and shared among multiple drivers as shown in FIG. 9B. Thus, the cascaded driver MOS 215a and 215b can be shared in multiple inter domain connections.

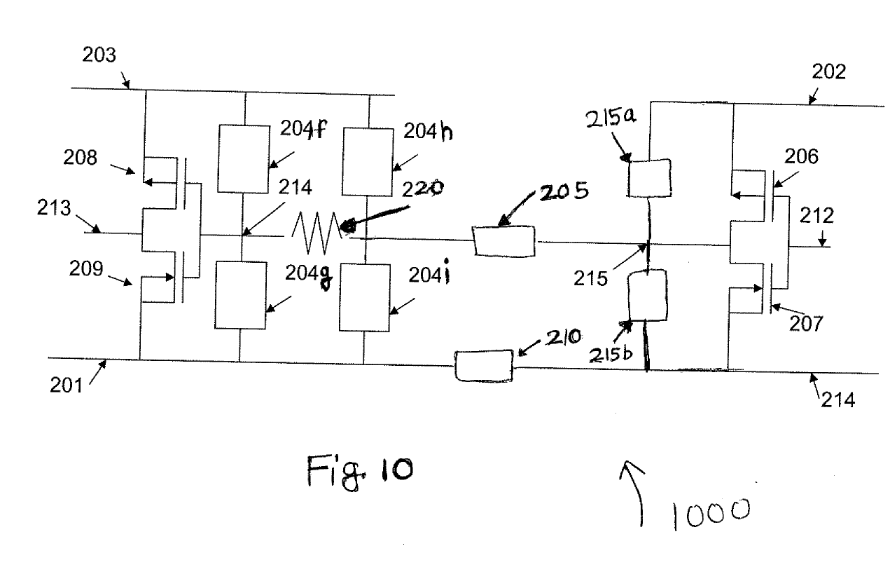

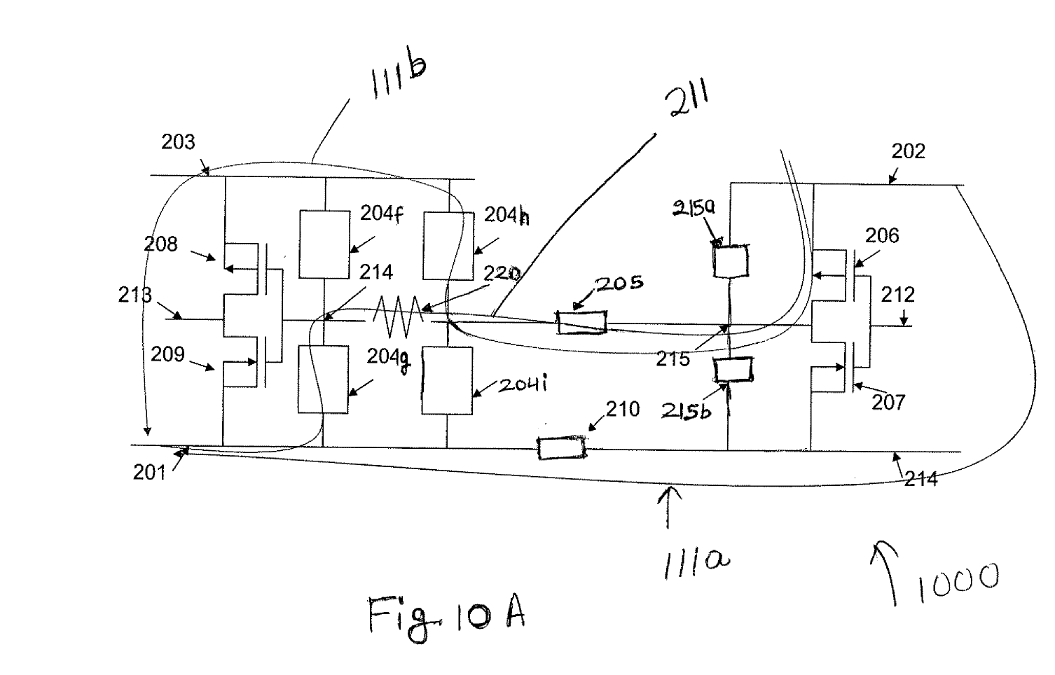

Referring to FIGS. 10 and 10A, there is shown another embodiment of the improved inter-domain ESD protection circuit 1000 of the present invention. In this embodiment, the local clamps 204a and 204b of the circuit 200 of FIG. 2 can also consist of a secondary protection approach. Specifically, in this circuit 1000, clamp 204a of FIG. 2 consists of clamps 204f and 204g and clamp 204b of FIG. 2 consists of clamps 204h and 204i, respectively. Also included in the circuit is resistor 220 positioned between the clamps 204f/204g and 204h/204i. As illustrated in FIG. 10A, the main part of current 111b is conducted by clamps 204h and 204i, while a third small part of the current is conducted by 204f, and 204g through the resistor 218. Thus, in this implementation, extra voltage is provided through the resistor 220. Furthermore, even though, not shown, in many cases where the added current sinking capability is not required, elements 215a and 215h can be eliminated from the circuit 1000.

Although various embodiments that incorporate the teachings of the present invention have been shown and described in detail herein, those skilled in the art can readily devise many other varied embodiments that still incorporate these teachings without departing from the spirit and the scope of the invention.

1. An electrostatic discharge (ESD) protection circuit for protecting an integrated circuit with multiple power domains, comprising:
at least a first MOS transistor coupled between a first voltage supply line and a first ground potential;
at least a second MOS transistor coupled between a second voltage supply line and one of the first ground potential and a second ground potential;
at least a first ESD clamp coupled between the first voltage supply line and the first ground potential; said at least first ESD clamp placed parallel to the at least a first MOS transistor;
at least a second ESD clamp coupled between the second voltage supply and the at least one of the first and second ground potential; said at least second ESD clamp placed parallel to the at least a second MOS transistor;
at least one impedance circuit positioned between the at least first MOS transistor and the at least second MOS transistor, wherein said at least a first ESD clamp conducts current and provides at least a portion of the current in the impedance circuit in response to an ESD event.

2. The ESD protection circuit according to claim 1 wherein said impedance circuit, said at least first MOS transistor and said at least second MOS transistor form an interface between said first and second voltage supply lines.

3. The ESD protection circuit according to claim 1 wherein said impedance circuit comprises at least one of a resistor, a capacitor, an inductor and a diode.

4. The ESD protection circuit according to claim 1 wherein said impedance circuit comprise at least one active device.

5. The ESD protection circuit according to claim 1 wherein said impedance circuit comprise a variable impedance element having a controllable impedance value.

6. The ESD protection circuit according to claim 1 wherein said at least a first ESD clamp comprise at least one MOS transistor.

7. The ESD protection circuit according to claim 1 wherein said at least a first ESD clamp comprise at least one diode.

8. The ESD protection circuit according to claim 1 wherein said impedance circuit connects the drain of the at least a first MOS transistor to a gate of the at least a second MOS transistor.

9. The ESD protection circuit according to claim 1 wherein said at least portion of the current increases the voltage across the impedance circuit to prevent breakdown of one of the at least first and second MOS transistor.

10. The ESD protection circuit according to claim 1 further comprising at least a third ESD clamp positioned in series to the at least second ESD clamp, wherein said at least third ESD clamp conducts current in response to the ESD event.

11. The ESD protection circuit according to claim 9 wherein said at least a third ESD clamp is coupled between the at least one of the first and second ground potential and the at least second MOS transistor.

12. The ESD protection circuit according to claim 9 wherein said at least at least a third ESD clamp is coupled between the second voltage supply line and the at least a second MOS transistor.

13. The ESD protection circuit according to claim 1 further comprising a second impedance circuit positioned between the first and the second ground potentials.

14. The ESD protection circuit according to claim 1 wherein said second ESD clamp comprise two ESD clamps with a resistor positioned between the two ESD clamps.

15. An electrostatic discharge (ESD) protection circuit for protecting an integrated circuit with multiple power domains, comprising:
at least a first MOS transistor coupled between a first voltage supply line and a first ground potential;
at least a second MOS transistor coupled between a second voltage supply line and one of the first ground potential and a second ground potential;
at least a first ESD clamp coupled between the first voltage supply line and the first ground potential; said at least first ESD clamp placed parallel to the at least first MOS transistor;
at least one impedance circuit positioned between the at least first MOS transistor and the at least second MOS transistor;
at least a second ESD clamp placed between the drain of the second MOS and the gate of the second MOS, wherein said at least first and second ESD clamps conduct current and provides at least a portion of the current in the impedance circuit in response to an ESD event.

16. The ESD protection circuit according to claim 15 wherein said impedance circuit, said at least first MOS transistor and said at least second MOS transistor form an interface between said first and second voltage supply line.

17. The ESD protection circuit according to claim 15 further comprising a second impedance circuit positioned between the first and the second ground potentials.

18. An electrostatic discharge (ESD) protection circuit for protecting an integrated circuit with multiple power domains, comprising:
a first protection circuit comprising:
at least a first MOS transistor coupled between a first voltage supply line and a first ground potential;
at least a second MOS transistor coupled between a second voltage supply line and at least one of the first and a second ground potential;
at least a first ESD clamp coupled between the first voltage supply line and the first ground potential, said at least first ESD clamp placed parallel to the at least first MOS transistor;
at least a second ESD clamp coupled between the second voltage supply line and the at least one of the first and the second ground potentials; said at least a second ESD clamp placed parallel to the at least second MOS transistor;
at least one first impedance circuit positioned between the at least first MOS transistor and the at least second MOS transistor, wherein said at least first ESD clamp conducts current and provides at least a portion of the current in the impedance circuit in response to an ESD event;
a second protection circuit comprising:
at least a third MOS transistor coupled between a third voltage supply line and a third ground potential;
at least a fourth MOS transistor coupled between a fourth voltage supply line and the at least one of the third and a fourth ground potential;
at least a third ESD clamp coupled between the third voltage supply line and the third ground potential; said at least third ESD clamp placed parallel to the at least third MOS transistor;
at least a fourth ESD clamp coupled between the fourth voltage supply line and the at least one of the third and the fourth ground potentials; said at least a fourth ESD clamp placed parallel to the at least fourth MOS transistor;
at least one second impedance circuit positioned between the at least third MOS transistor and the at least fourth MOS transistor, wherein said at least third ESD clamp conducts current and provides at least a portion of the current in the impedance circuit in response to an ESD event; and
an ESD detector coupled to the first protection circuit and the second protection circuit.

19. The ESD protection circuit according to claim 18 wherein said ESD detector is an transient detector.

20. The ESD protection circuit according to claim 18 wherein said ESD detector is coupled to the first ESD clamp of the first protection circuit and to the second ESD clamp of the second protection circuit.

21. The ESD protection circuit according to claim 18 wherein said ESD detector is coupled to the third ESD clamp of the first protection circuit and the fifth ESD clamp of the second protection circuit.

22. An electrostatic discharge (ESD) protection circuit for protecting an integrated circuit with multiple power domains, comprising:
a first protection circuit comprising:
at least a first MOS transistor coupled between a first voltage supply line and a first ground potential;
at least a second MOS transistor coupled between a second voltage supply line and at least one of the first and a second ground potential;
at least one first impedance circuit positioned between the at least first MOS transistor and the at least second MOS transistor;
at least a first ESD clamp coupled between the second voltage supply line and the at least one of the first and the second ground potentials; said at least first ESD clamp placed parallel to the at least second MOS transistor and conducts current in response to an ESD event;
a second protection circuit comprising:
at least a third MOS transistor coupled between a third voltage supply line and a third ground potential;
at least a fourth MOS transistor coupled between a fourth voltage supply line and the at least one of the third and a fourth ground potential;
at least one second impedance circuit positioned between the at least third MOS transistor and the at least fourth MOS transistor;
at least a second ESD clamp coupled between the fourth voltage supply line and the at least one of the third and the fourth ground potentials; said at least a second ESD clamp placed parallel to the at least a fourth MOS transistor and conducts current in response to an ESD event; and
an ESD detector coupled to the first protection circuit and the second protection circuit.

23. An electrostatic discharge (ESD) protection circuit for protecting an integrated circuit with multiple power domains, comprising:
at least a first MOS transistor coupled between a first voltage supply line and a first ground potential;
at least a second MOS transistor coupled between a second voltage supply line and at least one of the first and a second ground potential;
at least a first ESD clamp coupled in series between the first voltage supply line and the at least first MOS transistor;
at least a second ESD clamp coupled between the second voltage supply line and the at least one of the first and the second ground potentials; said at least a second ESD clamp placed parallel to the at least second MOS transistor;
at least one impedance circuit positioned between the at least first MOS transistor and the at least second MOS transistor, wherein said at least first ESD clamp conducts current and provides at least a portion of the current in the impedance circuit in response to an ESD event.

24. The ESD protection circuit according to claim 23 wherein said first ESD clamp comprise a MOS transistor.

25. The ESD protection circuit according to claim 23 further comprising a second impedance circuit placed between the first and the second ground potentials.

26. An electrostatic discharge (ESD) protection circuit for protecting an integrated circuit with multiple power domains, comprising:
a first protection circuit comprising:
at least a first MOS transistor coupled between a first voltage supply line and a first ground potential;
at least a second MOS transistor coupled between a second voltage supply line and at least one of the first and a second ground potential;
at least a first ESD clamp coupled in series between the first voltage supply line and the at least first MOS transistor;
at least a second ESD clamp coupled between the second voltage supply line and the at least one of the first and the second ground potential; said at least a second ESD clamp placed parallel to the at least second MOS transistor;
at least one first impedance circuit positioned between the at least first MOS transistor and the at least second MOS transistor, wherein said at least first ESD clamp conducts current and provides at least a portion of the current in the at least one first impedance circuit in response to an ESD event.
a second protection circuit comprising:
at least a third MOS transistor coupled in series with the at least first ESD clamp and the first ground potential;
at least a fourth MOS transistor coupled between a third voltage supply line and a third ground potential;
at least a fourth ESD clamp coupled between the third voltage potential and the third ground potential; said at least a fourth ESD clamp placed parallel to the at least a fourth MOS transistor;
at least one second impedance circuit positioned between the at least third MOS transistor and the at least fourth MOS transistor,
wherein said at least first ESD clamp of the first protection circuit conduct current and provide at least a portion of the current in the at least one second impedance circuit of the second protection unit in response to an ESD event.

27. The ESD protection circuit according to claim 24 wherein said first ESD clamp comprise a MOS transistor.
